(19) United States
(12) Patent Application Publication
(10) Pub. No.: US 2015/0186429 A1
(43) Pub. Date: Jul. 2, 2015

(54) METHOD AND SYSTEM FOR DATA DISPATCH PROCESSING IN A BIG DATA SYSTEM

(71) Applicant: Industrial Technology Research Institute, Hsinchu (TW)

(72) Inventors: You-Lin Chen, Changhua County (TW); Leii H. Chang, Hsinchu County (TW); En-Jung Farn, Hsinchu City (TW); Nien-Chu Wu, Taoyuan County (TW)

(21) Appl. No.: 14/490,685

(22) Filed: Sep. 19, 2014

(30) Foreign Application Priority Data
Dec. 30, 2013 (TW) 102149044

(51) Int. Cl. G06F 17/30

(52) U.S. Cl. CPC G06F 17/30289; G06F 17/30318

(57) ABSTRACT

A system and a method for data dispatch processing in a big data system are provided. The system includes a plurality of computing machines and a database cluster. The method includes disassembling a computing procedure into a plurality of processing elements. The method also includes identifying a database accessing point for accessing a target data node from one of the data nodes in the computing procedure. The method further includes configuring the processing elements to the computing machines according to the database accessing point, and transmitting a data tuple corresponding to the computing procedure according to the processing elements configured to the computing machines and a data transmitting cost between the computing machines. Accordingly, the method effectively improves system performance for transmitting the big data.

### CROSS-REFERENCE TO RELATED APPLICATION

This application claims the priority benefit of Taiwan application serial no. 102149044, filed on Dec. 30, 2013. The entirety of the above-mentioned patent application is hereby incorporated by reference herein and made a part of this specification.

### BACKGROUND

1. Technical Field

The disclosure relates to a method and a system for data dispatch processing in a big data system.

2. Related Art

Along with the development of computer technology and the significant progress of Internet and multimedia technology, the amount of global data is rapidly increasing, and the data is generally presented in digital form. To facilitate acquiring the required data quickly for the public, the techniques for processing big data draw more and more attention. In order to provide the computing capability for processing big data, the technology of cloud computing that connects a large number of computing devices becomes a major solution. The most wide spread implementation is Hadoop-based batch computing systems and various database clusters. However, such technique is capable of processing a large amount of static data, but is not suitable for processing a large amount of continually generated dynamic data. Such that stream computing is used as a main technique for processing the large amount of real-time dynamic data. However, regarding processing of big data, single demand for static data or dynamic data processing is not enough. The large number of events that occur continually in real-time require instant analysis and reaction, and meanwhile the processed data is required to be stored for later query and advanced analysis, such that the system must effectively integrate the processing capabilities of both static data and dynamic data.

Along with the increasing large amount of data, the old database or data warehouse systems are insufficient to store all of the data through a single machine, so that a database cluster architecture that connects a plurality of machines is widely used to provide an expandable data storage amount. Under the database cluster architecture, it is unnecessary to understand the data storing mechanism for accessing the database. Namely, all the client has to do is perform the task of data accessing through the unified interface of the database and have the database management system allocate a storage position of the data according to a database index of each batch of data without the necessity of knowing in which machine the data is actually stored. Although the above method is easy on data accessing, the data storage mechanism is unknown during the data computing process since the current computing system and the database cluster are separate architectures, i.e. it is unknown as to which machine the required data accessed from the database is actually stored, which leads to a result that in a system integrating of big data computation and big data storage, optimisation of data computation performed according to the data storage position cannot be implemented, causing the increasing in data transmission and decreasing in system performance. If the storage mechanism of the database cluster is known in the computing procedure, i.e. if a physical machine to which each batch of data in the database cluster corresponds is learned, the performance in the system that integrates the big data computation and big data storage can be improved.

### SUMMARY

The disclosure is related to a method and a system for data dispatch processing in a big data system, by which data computation and storage tasks are dispersed to each machine in the system, and computing resources and data tuples are dynamically allocated according to an operation mechanism of the database.

The disclosure provides a method for data dispatch processing in a big data system, which is adapted to execute a computing procedure through a plurality of computing machines and a database cluster, the method includes following steps. The computing procedure is analysed and disassembled into a plurality of processing elements. At least one database accessing point for accessing at least one target data node of data nodes in the computing procedure is identified, wherein the at least one database accessing point is located in the processing element. The corresponding processing elements are configured to the computing machines according to the at least one database accessing point. At least one data tuple corresponding to the computing procedure is transmitted according to the processing elements configured to the computing machines and a data transmission cost between the computing machines.

The disclosure provides a system for data dispatch processing in a big data system, which is adapted to execute a computing procedure. The system includes a plurality of computing machines, a database cluster and a data dispatch processing control unit. The plurality of computing machines are connected to each other through a network, and the database cluster has a plurality of data nodes and each of the data nodes is disposed in one of the computing machines, and the data dispatch processing control unit is configured to analysis and disassemble the computing procedure into a plurality of processing elements. The dispatch processing control unit identifies at least one database accessing point for accessing at least one target data node of data nodes in the computing procedure, where the at least one database accessing point is located in the processing element. Moreover, the data dispatch processing control unit is further configured to configure the corresponding processing elements on the plurality of computing machines according to the at least one database accessing point, and transmits at least one data tuple corresponding to the computing procedure according to the processing elements configured to the plurality of computing machines and a data transmission cost between the computing machines.

According to the above descriptions, the method and the system for data dispatch processing in a big data system, are capable of knowing the stored physical machine of each data tuple according to the operation mechanism of the database in the computing procedure, so as to dynamically allocate computing resources and data tuples to achieve the objective of improving the performance in the system that integrates the big data computation and big data storage.

In order to make the aforementioned and other features of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a flowchart illustrating a method for data dispatch processing according to the disclosure.

FIG. 2 is a block diagram of a system for data dispatch processing according to a first exemplary embodiment of the disclosure.

FIG. 3 is a schematic diagram of disassembling a computing procedure into a plurality of processing elements (PE) according to the first exemplary embodiment of the disclosure.

FIG. 4 is a flowchart illustrating configuration of processing elements according to the first exemplary embodiment of the disclosure.

FIG. 5A and FIG. 5B are schematic diagrams illustrating data transmission links and configuration of data dispatch elements (DDE) according to the first exemplary embodiment of the disclosure.

FIG. 6 is a flowchart illustrating a configuration of data dispatch elements according to the first exemplary embodiment of the disclosure.

FIG. 7 is a flowchart illustrating establishing a routing table according to the first exemplary embodiment of the disclosure.

FIG. 8 is a schematic diagram illustrating operations of a data transmission module and a computing procedure analysis module according to the first exemplary embodiment of the disclosure.

FIG. 9 is a schematic diagram illustrating a configuration of processing elements (PE) and data dispatch elements (DDE) according to the first exemplary embodiment of the disclosure.

FIG. 10 is a schematic diagram illustrating another configuration of the processing elements (PE) and the data dispatch elements (DDE) according to the first exemplary embodiment of the disclosure.

FIG. 11 is a schematic diagram of another data tuple dispatch processing path according to the first exemplary embodiment of the disclosure.

FIG. 12 is a schematic diagram of a data tuple dispatch processing path where two different data nodes are to be accessed in the computing procedure according to the first exemplary embodiment of the disclosure.

FIG. 13A and FIG. 13B illustrate a directed graph with a plurality of vertices formed by the processing elements and the data dispatch elements according to the first exemplary embodiment of the disclosure.

FIG. 14 is a flowchart illustrating dispatching a data tuple according to a second exemplary embodiment of the disclosure.

FIG. 15 is a schematic diagram of a processing path for immediately dispatching a data tuple in light of a database index according to the second exemplary embodiment of the disclosure.

### DETAILED DESCRIPTION OF DISCLOSED EMBODIMENTS

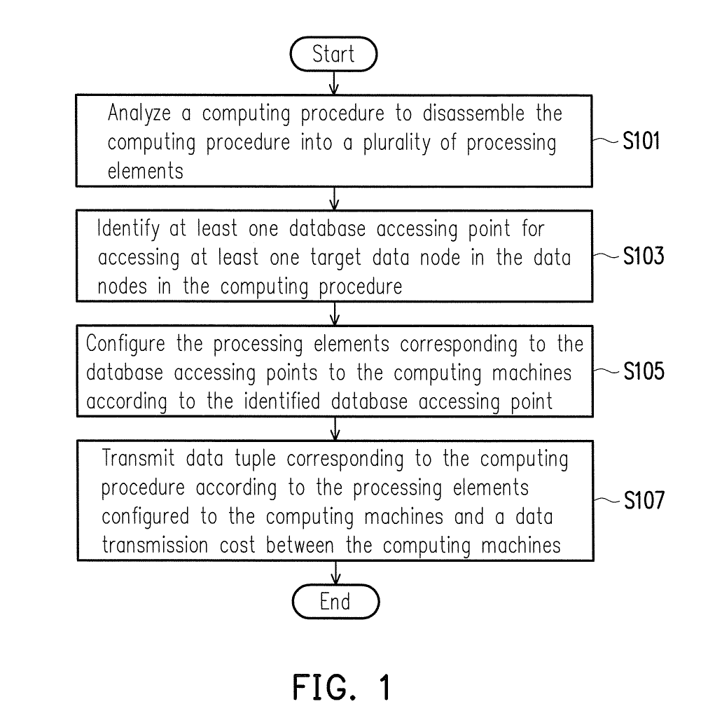

FIG. 1 is a flowchart illustrating a method for data dispatch processing according to the disclosure. In order to dynamically distribute computing resources and data tuples, the disclosure provides a method for data dispatch processing. Referring to FIG. 1, the method includes following steps. A computing procedure is analysed and disassembled into a plurality of processing elements (S101). At least one database accessing point for accessing at least one target data node of a plurality of data nodes in the computing procedure is identified (S103). The processing elements corresponding to the database accessing points are configured to a plurality of computing machines according to the identified database accessing points (step S105). A data tuple corresponding to the computing procedure is transmitted according to the processing elements configured to the computing machines and a data transmission cost between the computing machines (S107). The processing elements are linked according to a logic operation flow of the computing procedure, and are used for executing a series of computing instructions. In other words, one processing element includes a part of the computing instructions of the computing procedure. Particularly, the processing elements can be used to process a data stream, and the data stream is disassembled into data tuples between the processing elements to serve as a transmitting unit, wherein the data tuple is data with a limited size. The data node is a physical element used for storing data, and one data node exists in one physical machine. The database accessing point is a computing instruction in the computing procedure that actually reads data from or writes data into the data node, wherein the database accessing point is included in the processing elements. Accordingly, the method for data dispatch processing can implement optimisation processing on the data computation according to a data storage position, so as to decrease the data transmission cost and a workload to improve system performance. In order to clearly introduce the disclosure, exemplary embodiments are described below with reference of figures.

### First Exemplary Embodiment

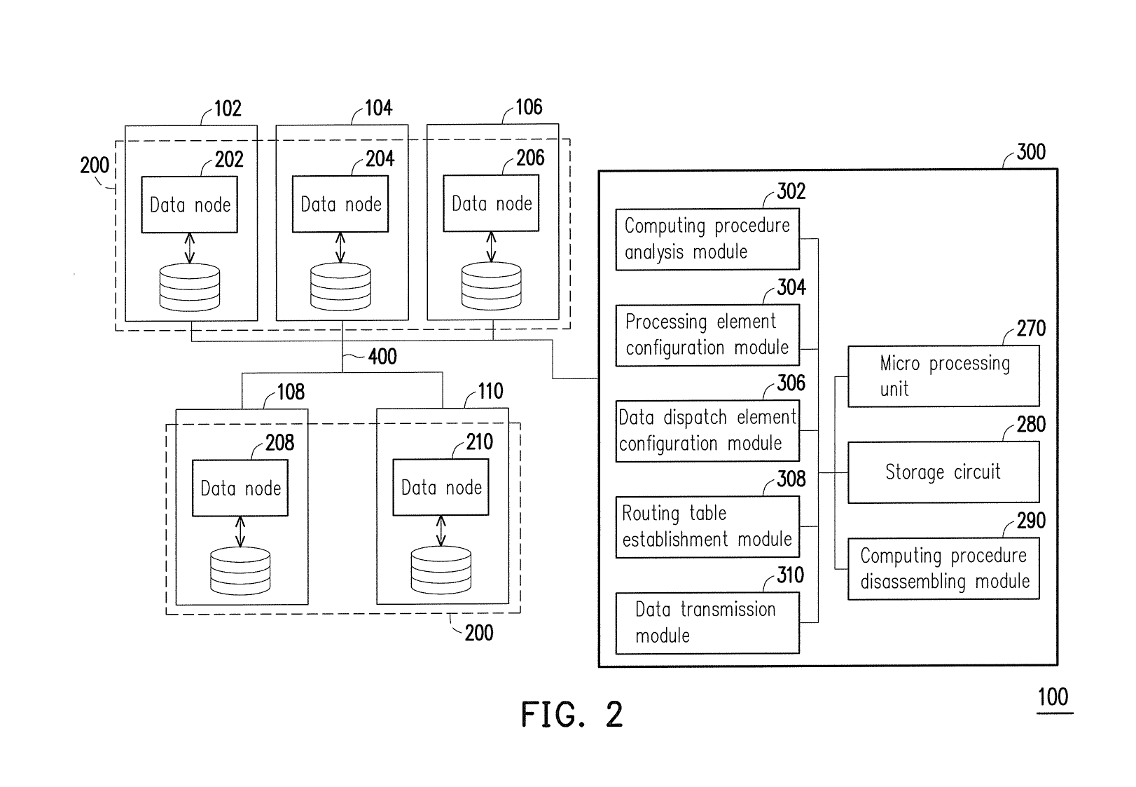

FIG. 2 is a block diagram of a system for data dispatch processing according to the first exemplary embodiment of the disclosure. It should be noticed that the embodiment of FIG. 2 is for explaining conveniently, which is not used to limit the disclosure.

Referring to FIG. 2, the system for data dispatch processing 100 in a big data system includes a first computing machine 102, a second computing machine 104, a third computing machine 106, a fourth computing machine 108, a fifth computing machine 110, a database cluster 200 and a data dispatch processing control unit 300.

The first computing machine 102, the second computing machine 104, the third computing machine 106, the fourth computing machine 108 and the fifth computing machine 110 are connected to each other through a network 400. In the present exemplary embodiment, each of the computing machines (i.e. the first computing machine 102, the second computing machine 104, the third computing machine 106, the fourth computing machine 108 and the fifth computing machine 110) has a central processor and a storage device (not shown) used for processing and storing data. For example, the first computing machine 102, the second computing machine 104, the third computing machine 106, the fourth computing machine 108 and the fifth computing machine 110 can be personal computer, servers, etc.

The database cluster 200 is a database system that stores data by using the storage devices of a plurality of physical machines, wherein the database cluster 200 has a plurality of data nodes 202, 204, 206, 208 and 210. The data nodes are elements that actually store data content in the database cluster, and one database cluster includes a plurality of data nodes, where one data node is located on one physical machine. For example, as shown in FIG. 2, the data node 202 is disposed on the first computing machine 102, and the data nodes 204, 206, 208 and 210 are respectively disposed on the computing machines 104, 106, 108 and 110.

The data dispatch processing control unit 300 is connected to the first computing machine 102, the second computing machine 104, the third computing machine 106, the fourth computing machine 108 and the fifth computing machine 110 through the network 400, and is used for managing the first computing machine 102, the second computing machine 104, the third computing machine 106, the fourth computing machine 108 and the fifth computing machine 110 to execute a computing procedure. For example, the data dispatch processing control unit 300 can be disposed in a personal computer, a server, etc.

The data dispatch processing control unit 300 includes a micro processing unit 270, a storage circuit 280, a computing procedure disassembling module 290, a computing procedure analysis module 302, a processing element configuration module 304, a data dispatch element configuration module 306, a routing table establishment module 308 and a data transmission module 310.

The micro processing unit 270 is used for controlling a whole operation of the data dispatch processing control unit 300.

The storage circuit 280 is used for storing program or data required in operation of the data dispatch processing control unit 300. For example, the storage circuit 280 can be a conventional hard disc, a solid state drive, a rewritable memory, etc.

The computing procedure disassembling module 290 is coupled to the micro processing unit 270, and is used for analysing and disassembling the computing procedure into a plurality of processing elements, such that the computing procedure can be implemented by executing the processing elements.

The computing procedure analysis module 302 is coupled to the micro processing unit 270, and is used for identifying at least one database accessing point for accessing at least one target data node of the data nodes in the computing procedure. In detail, the database accessing point is a computing instruction in the computing procedure that actually reads data from or writes data into the data node, and the database accessing point is included in the processing elements.

In the present exemplary embodiment, the computing procedure analysis module 302 further identifies at least one database index identification point corresponding to the at least one database accessing point in the computing procedure, and further identifies at least one database index at the at least one database index identification point, and queries the database cluster to obtain the target data node according to the identified database index. In detail, the database index is a basis for the database to determine the storage position of the data tuple, while the database index identification point is the first computing instruction that the database index of the corresponding database accessing point can be identified.

The processing element configuration module 304 is coupled to the micro processing unit 270 and is used for assigning the corresponding processing element to the first computing machine 102, the second computing machine 104, the third computing machine 106, the fourth computing machine 108 and the fifth computing machine 110, wherein each of the processing elements is at least configured to one of the computing machines.

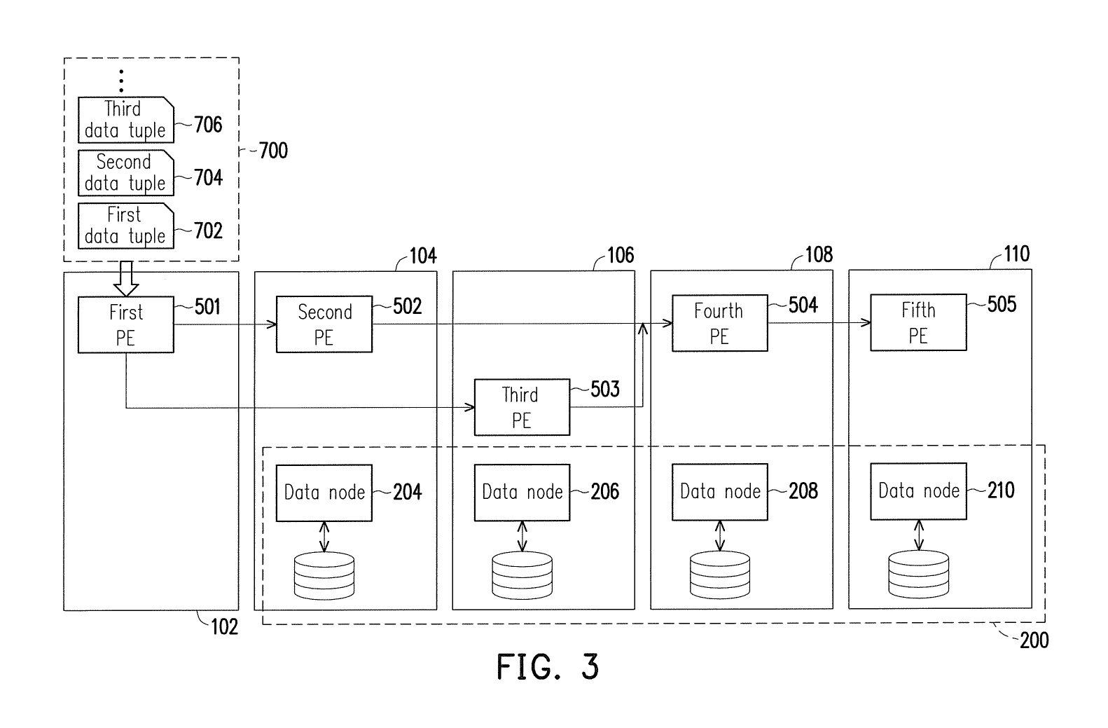

FIG. 3 is a schematic diagram of disassembling the computing procedure into a plurality of processing elements (PE) according to the first exemplary embodiment of the disclosure.

Referring to FIG. 3, the computing procedure disassembling module 290 disassembles a computing procedure into a first processing element (PE) to a fifth processing element (PE) (501-505), and the processing element configuration module 304 configures the disassembled processing element to the computing machines. For example, the first processing element 501 is configured to the first computing machine 102, the second processing element 502 is configured to the second computing machine 104, the third processing element 503 is configured to the third computing machine 106, the fourth processing element 504 is configured to the fourth computing machine 108, and the fifth processing element 505 is configured to the fifth computing machine 110. The first data tuple 702, the second data tuple 704 and the third data tuple 706 are respectively different data tuples, because of the difference of time or content of the data tuples, and the data stream 700 shown in FIG. 3 is a data stream generated when the data tuples of different time or contents enter the system for data dispatch processing. It should be noticed that flowing of a same data tuple between different processing elements will also produce a data stream, and after the processing of the processing element, it may result in change of the content or state of the data tuple. Different data tuples probably use the same or different data nodes, and the same data tuple flowed between different processing elements probably uses one or a plurality of different data nodes.

In the present exemplary embodiment, when the processing elements are configured to the computing machines, the processing element configuration module 304 configures the processing elements according to the database accessing point identified by the computing procedure analysis module 302. Particularly, the processing element configuration module 304 will have the processing element corresponding to the database accessing point be configured in priority to the computing machine having the target data node corresponding to the database accessing point. In FIG. 3, to facilitate the illustration in association with the following figures, one processing element is configured to each computing machine. It should be noticed that a configuration principle of the processing elements is that each processing element is configured to at least one computing machine; however, the disclosure is not limited to the situation that each computing machine is configured with one processing element or each computing machine must be configured with at least one processing element.

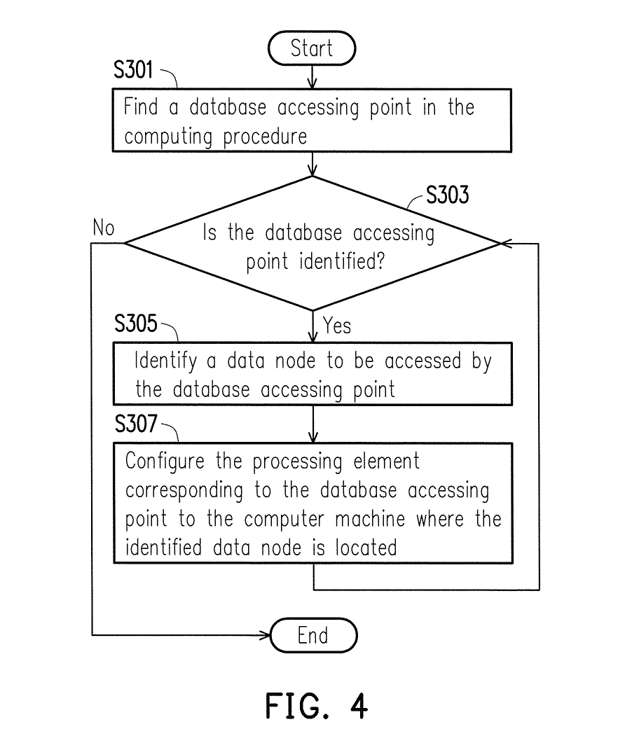

FIG. 4 is a flowchart illustrating configuration of the processing elements according to the first exemplary embodiment of the disclosure.

Referring to FIG. 4, in step S301, the computing procedure analysis module 302 finds the database accessing point in the computing procedure. Then, in step S303, the processing element configuration module 304 determines whether the computing procedure analysis module 302 finds the database accessing point. If the database accessing point is found, in step S305, the processing element configuration module 304 further identifies a data node to be accessed according to the database accessing point found by the computing procedure analysis module 302. Then, in step S307, the processing element configuration module 304 configures the processing element corresponding to the database accessing point to the computing machine where the identified data node is located.

In the step S303, if the database accessing point is not identified, the processing element configuration module 304 will not additionally configure the processing element.

It should be noticed that in another exemplary embodiment of the disclosure, in the step S307, a database router or a database client can be further configured to the computing machine where the identified data node is located. In detail, the database router is a data accessing interface of the database cluster, and the data node has to be accessed through the database router to ensure integrity and consistency of data in the data node. The database client is a lightweight database router, which has a part of functions of the database router. Particularly, the database client has to provide a function for querying database index to identify the data node corresponding to a data tuple index. In this way, identification of the data node corresponding to the database index can be directly queried through the database client without performing the query through the database router of the other computing machine.

Referring to FIG. 2, the data dispatch element configuration module 306 is coupled to the micro processing unit 270, and is used for finding data transmission links corresponding to each of the processing elements according to the processing elements obtained by disassembling the computing procedure by the computing procedure disassembling module 290, and configures a data dispatch element for each of the processing element according to the data transmission links.

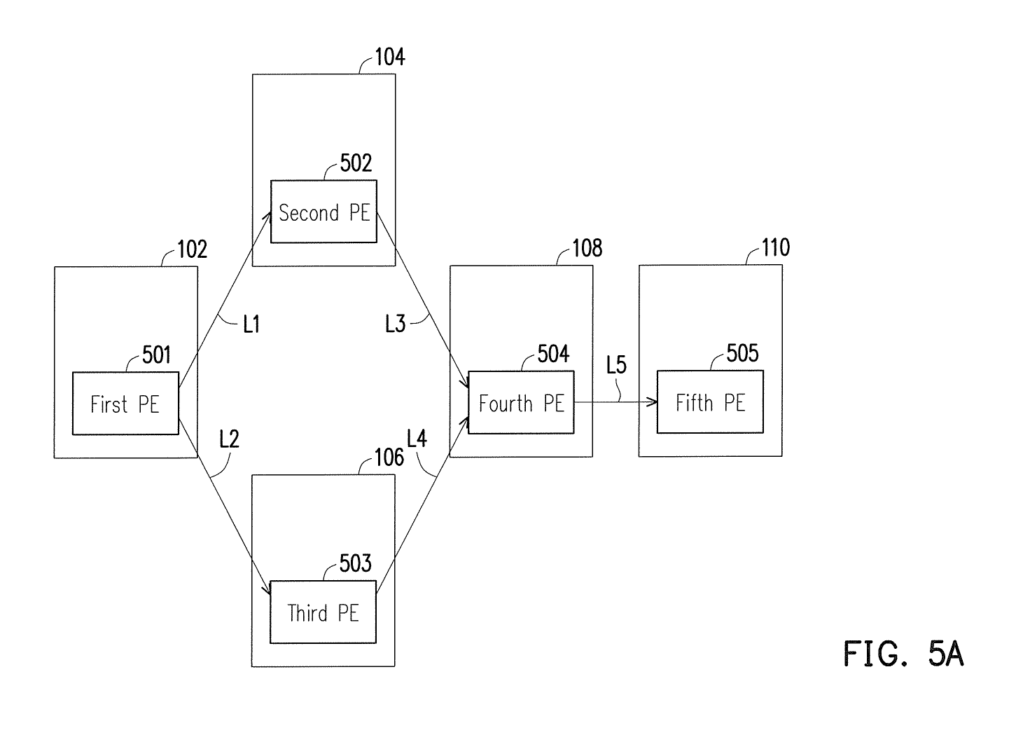

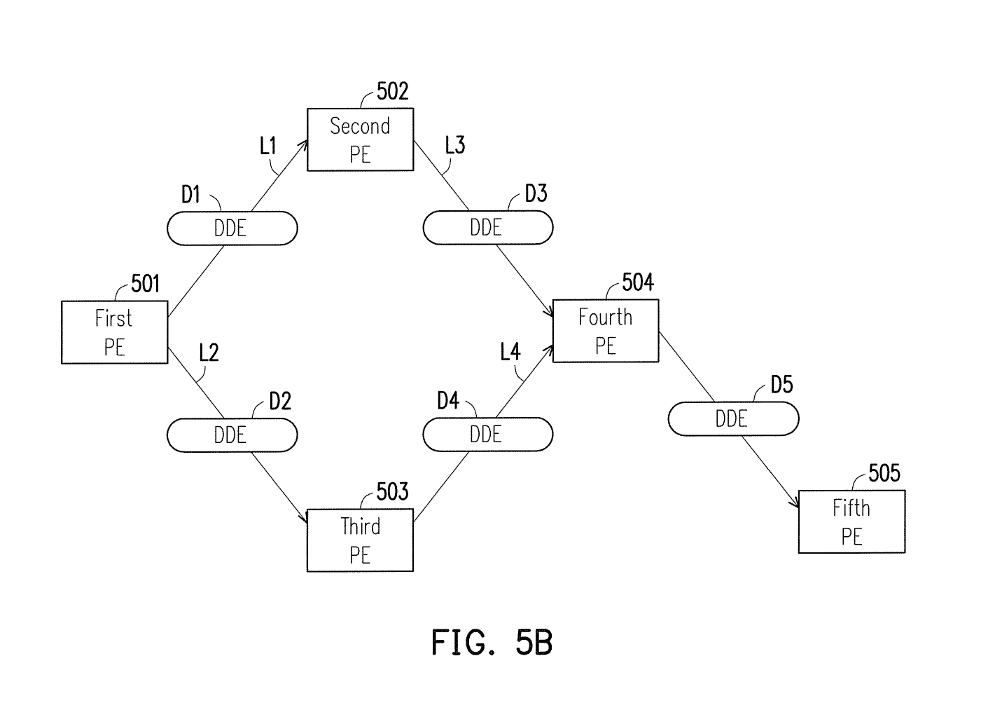

FIG. 5A and FIG. 5B are schematic diagrams illustrating data transmission links and configuration of the data dispatch elements according to the first exemplary embodiment of the disclosure.

Referring to FIG. 3 and FIG. 5A, the computing procedure of FIG. 5A is composed of five disassembled processing elements 501-505 shown in FIG. 3, wherein the processing flow of the data tuples is shown by directed links of FIG. 5A. For example, the first processing element 501 determines to allocate data generated by the first processing element 501 to the second processing element 502 or the third processing element 503 to process, and the data processed by the second processing element 502 or the third processing element 503 is delivered to the fourth processing element 504 for processing, and finally the data processed by the fourth processing element 504 is delivered to the fifth processing element 505 for processing. Therefore, according to the processing flow of the computing procedure, the data dispatch element configuration module 306 can find data transmission links L1 through L5 of each of the processing elements respectively.

Referring to FIG. 5B, FIG. 5B is a schematic diagram illustrating a situation that the data dispatch element configuration module 306 configures the data dispatch elements (DDE) on the data transmission links L1 through L5 of each of the processing elements (PE) found in FIG. 5A. The data dispatch element configuration module 306 configures the data dispatch elements D2 through D5 on each of the data transmission links L1 through L5, wherein the data dispatch element is used for delivering the data tuple to the corresponding processing element. For example, the data dispatch element D2 corresponds to the second processing element 502, so that the data dispatch element D2 is indicated as a data dispatch element that delivers the data to the second processing element 502 for processing. Similarly, the data dispatch element D3 is indicated as a data dispatch element that delivers the data to the third processing element 503 for processing, the data dispatch element D4 is indicated as a data dispatch element that delivers the data to the fourth processing element 504 for processing, and the data dispatch element D5 is indicated as a data dispatch element that delivers the data to the fifth processing element 505 for processing.

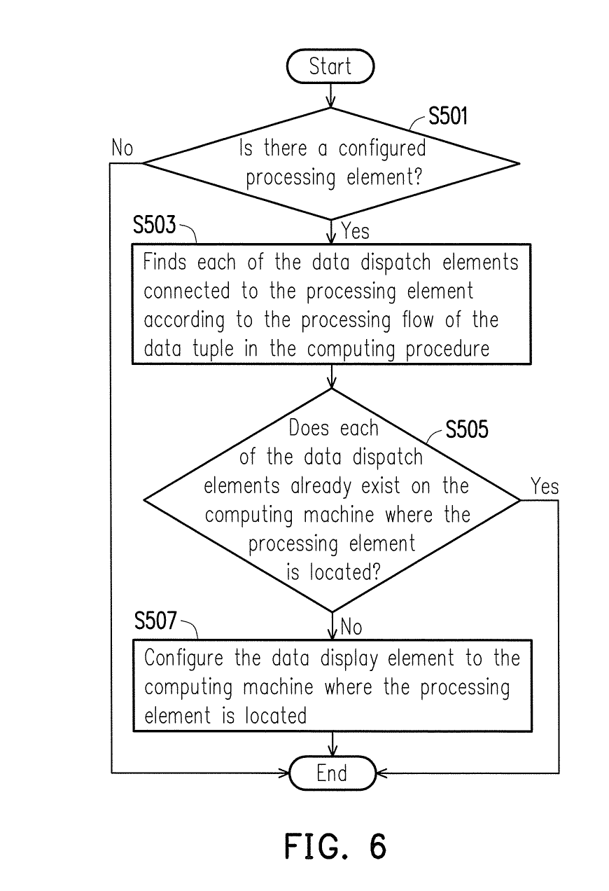

FIG. 6 is a flowchart illustrating a configuration of data dispatch elements according to the first exemplary embodiment of the disclosure.

Referring to FIG. 6, first of all, in step S501, the data dispatch element configuration module 306 determines whether the processing element configuration module 304 configures the processing element, and if the processing element is configured, in step S503, the data dispatch element configuration module 306 will find out each of the data dispatch elements connected to the processing element according to the processing flow of the data tuple in the computing procedure.

Then, in step S505, the data dispatch element configuration module 306 determines whether each of the required data dispatch elements already exists on the computing machine where the processing element is located. If the data dispatch element corresponding to the processing element does not exist on the computing machine where the processing element is located, in step S507, the data dispatch element configuration module 306 configures the data dispatch element on the computing machine where the processing element is located. If the data dispatch element configuration module 306 determines that there is no additionally configured processing element in the step S501, or in the step S505, if the data dispatch element already exists on the computing machine where the processing element is located, the data dispatch element configuration module 306 does not configure the data dispatch element.

Referring to FIG. 2, the routing table establishment module 308 is coupled to the micro processing unit 270 for establishing a routing table for each of the data dispatch elements according to the plurality of processing elements configured to the plurality of computing machines and the data transmitting cost between the computing machines.

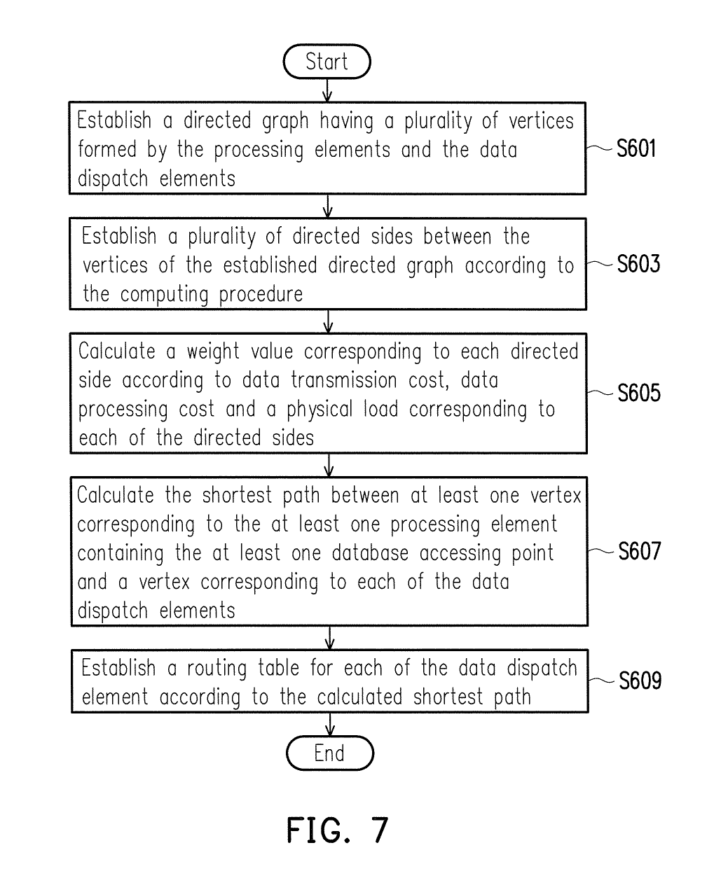

FIG. 7 is a flowchart illustrating establishing a routing table according to the first exemplary embodiment of the disclosure.

Referring to FIG. 7, first of all, in step S601, the routing table establishment module 308 establishes a directed graph having a plurality of vertices formed by the processing elements and the data dispatch elements. Then, in step S603, the routing table establishment module 308 further establishes a plurality of directed edges between the vertices of the established directed graph according to the computing procedure.

Then, in step S605, the routing table establishment module 308 calculates the weight value of each of the corresponding directed edge in light of the one in accordance with each of the group consisting of the data transmission overhead, the data processing overhead, and the physical load corresponding to each of the directed sides, where the data transmission overhead and the data processing overhead refer to resource consumption of computation performed when the data transmission path is selected and the data processing is performed, for example, time consumption and power consumption. The weight value is used for evaluating a length of a computing execution path, and the smaller the weight value is, the shorter the computing execution path is, and the computing execution path can be represented as an ordered sequence of the plural vertices in the directed graph. Moreover, in step S607, the routing table establishment module 308 calculates the shortest path between at least one vertex corresponding to the at least one processing element containing the at least one database accessing point and a vertex corresponding to each of the data dispatch elements.

Finally, in step S609, the routing table establishment module 308 establishes a routing table for each of the data dispatch element according to the calculated shortest path.

Referring to FIG. 2, the data transmission module 310 is coupled to the micro processing unit 270, and finds a preferred computing execution path corresponding to the computing procedure according to the routing table established by the routing table establishment module 308. In detail, the data transmission module 310 selects target processing elements corresponding to each of the processing elements from the processing elements of the computing machines to form the preferred computing execution path corresponding to the computing procedure. Particularly, in the present exemplary embodiment, the processing element executes the computing procedure according to the computing execution path, and the data dispatch element transmits at least one data tuple corresponding to the computing procedure according to the routing table mentioned in FIG. 7.

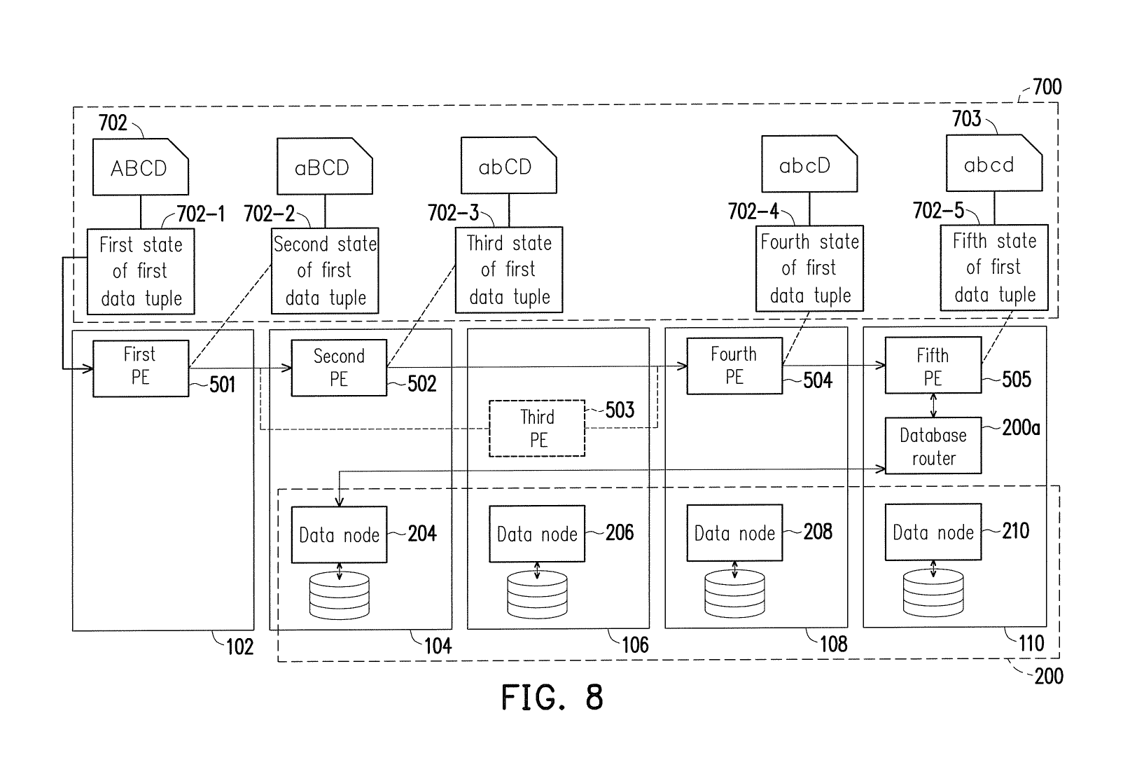

FIG. 8 is a schematic diagram illustrating operations of the data transmission module and the computing procedure analysis module according to the first exemplary embodiment of the disclosure.

Referring to FIG. 3 and FIG. 8, it is assumed that the computing procedure is composed of the disassembled first processing element (PE) 501 to the fifth processing element (PE) 505 shown in FIG. 3 and each of the processing elements (501-505) are respectively executed on the first computing machine 102 to the fifth computing machine 110, and the data stream 700 refers to a transition flow of the first data tuple 702 processed by the first processing element 501, the second processing element 502, the fourth processing element 504 and the fifth processing element 505. First of all, the first processing element 501 receives the first data tuple 702 with content of “ABCD”, and after the first data tuple 702 is processed by the first processing element 501, the content of the data tuple is changed to “aBCD”. Then, after processing of the second processing element 502, the content of the data tuble is changed to “abCD”, and after processing of the fourth processing element 504, the content of the data tuple is changed to “abcD”, and finally after processing of the fifth processing element 505, the data tuple is changed to a first data tuple 703 with content of “abcd”. It should be noticed that the computation performed on the data tuple by the processing element does not necessarily result in a change in the content, but sometimes result in a change of state (a first state 702-1 of the first data tuple to a fifth state 702-5 of the first data tuple), and sometimes perform query on the state in light of the data tuple. A conventional approach is to take “a” as a database index to request the database router 200a to perform a database write operation in the fifth computing machine 110. After the database router 200a performs query while taking “a” as the database index, it is learned that the data node corresponding to the database index is located at the second computing machine 104, and according to the conventional approach, the data tuple 703 is further transmitted to the second computing machine 104 for storage. The computing procedure analysis module 302 of the disclosure can identify the database index corresponding to the database accessing point contained in the fifth processing element 505 during processing of the second processing element 502 before the processing of the fifth processing element 505 is performed, i.e. during the processing of the second processing element 502, it is known that the data is to be stored at the data node 204 on the second computing machine 104 after processing.

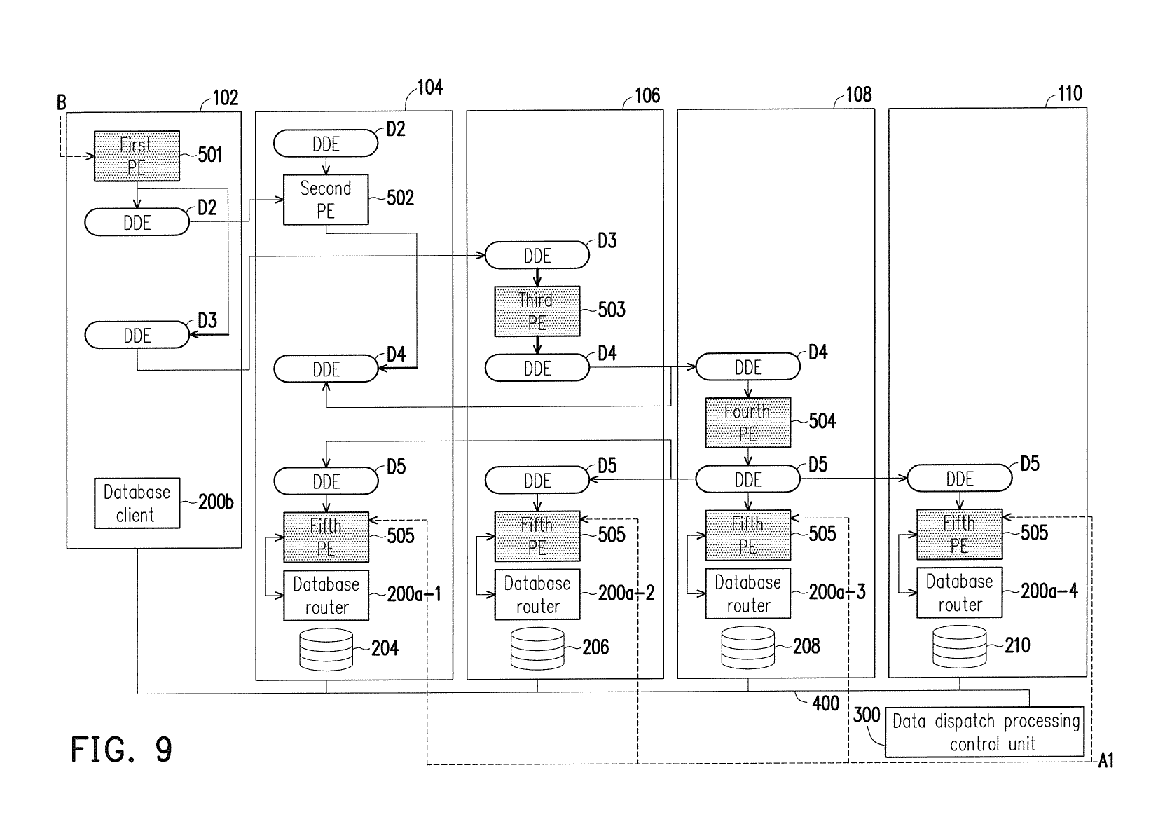

FIG. 9 is a schematic diagram illustrating a configuration of the processing elements (PE) and the data dispatch elements (DDE) according to the first exemplary embodiment of the disclosure.

Referring to FIG. 9, first of all, the computing procedure analysis module 302 identifies a database accessing point A1 for accessing the target data node of the data nodes in the computing procedure. Then, the computing procedure analysis module 302 identifies a database index identification point B corresponding to the database accessing point A1. Namely, the database accessing point A1 in the computing procedure is included in the fifth processing element 505, and the database index identification point B is included in the first processing element 501. In order to immediately query the corresponding data node after the first processing element 501 obtains the database index, the processing element configuration module 304 configures the first processing element 501 including the database index identification point B on the computing machine having the database router or the database client to improve performance. In the present embodiment, the first processing element 501 is configured to the first computing machine 102 having a database client 200b, and the fifth processing element 505 including the database accessing point is configured to all of the computing machines having data nodes corresponding to the database accessing point, so as to cover all of the data node probably accessed through various data tuples of the computing procedure. In the present exemplary embodiment, the fifth processing element 505 is disposed on the second computing machine 104, the third computing machine 106, the fourth computing machine 108 and the fifth computing machine 110, and the rest of processing elements are configured in at least one of the computing machines. In the present exemplary embodiment, similar to the processing method of FIG. 8, the second processing element 502, the third processing element 503, the fourth processing element 504 are respectively configured to the second computing machine 104, the third computing machine 106, and the fourth computing machine 108. Moreover, the data dispatch element configuration module 306 also configures the data dispatch elements corresponding to the processing elements. For example, after the first processing element 501 of the first computing machine 102 processes the data tuple, the data tuple is transmitted to the second processing element 502 on the second computing machine 104 or the third processing element 503 on the third computing machine 106. Therefore, the data dispatch element configuration module 306 configures data dispatch elements D2 and D3 on the first computing machine 102. The second processing element 502 on the second computing machine 104 receives the data tuple from the first computing machine 102, and the second processing element 502 processes the data tuple and transmits the data tuple to the fourth processing element 504 on the fourth computing machine 108. Particularly, the fourth processing element 504 can also receive data tuples that are transmitted to the fourth processing element 504 from other computing machines (for example, the third computing machine 106), process the data tuples, and then transmits to the fifth processing element 505. The data dispatch element configuration module 306 configures the data dispatch elements D2, D4 and D5 on the second computing machine 104, and the data dispatch element D4 of the second computing machine 104 can forward the data tuple, which is processed by the second processing element 502 of the second computing machine 104, to the data dispatch element D4 of the fourth computing machine 108. The third processing element 503 on the third computing machine 106 receives the data tuple from the first computing machine 102, and the third processing element 503 processes the data tuple and transmits the data tuple to the fourth processing element 504 on the fourth computing machine 108. Particularly, the fourth processing element 504 can also receive data tuples that are transmitted to the fourth processing element 504 from other computing machines (for example, the second computing machine 104), process the data tuples, and then transmits to the fifth processing element 505. The data dispatch element configuration module 306 configures the data dispatch elements D3, D4 and D5 on the third computing machine 106, and the data dispatch element D4 of the third computing machine 106 can forward the data tuple, which is processed by the third processing element 503 of the third computing machine 106, to the data dispatch element D4 of the fourth computing machine 108. The fourth processing element 504 on the fourth computing machine 108 receives the data tuple from the second or the third computing machine, and the fourth processing element 504 processes the data tuple and directly transmits the data tuple to the fifth processing element 505 on the same machine (the fourth computing machine 108), or transmits the data tuple to other computing machines having the fifth processing element 505, so that the data dispatch element configuration module 306 configures the data dispatch elements D4 and D5 on the fourth computing machine 108. The fifth processing element 505 on the fifth computing machine 110 can receive the data tuple from the other computing machines having the fifth data dispatch element D5, so that the data dispatch element configuration module 306 configures the data dispatch element D5 on the fifth computing machine 110. Moreover, each of the computing machines (104-110) configured with the fifth processing element 505 corresponding to the data nodes has a database router (200a-1˜200a-4), so that after the fifth processing element 505 processes the data tuple, the database accessing operation can be performed through the database router (200a-1˜200a-4).

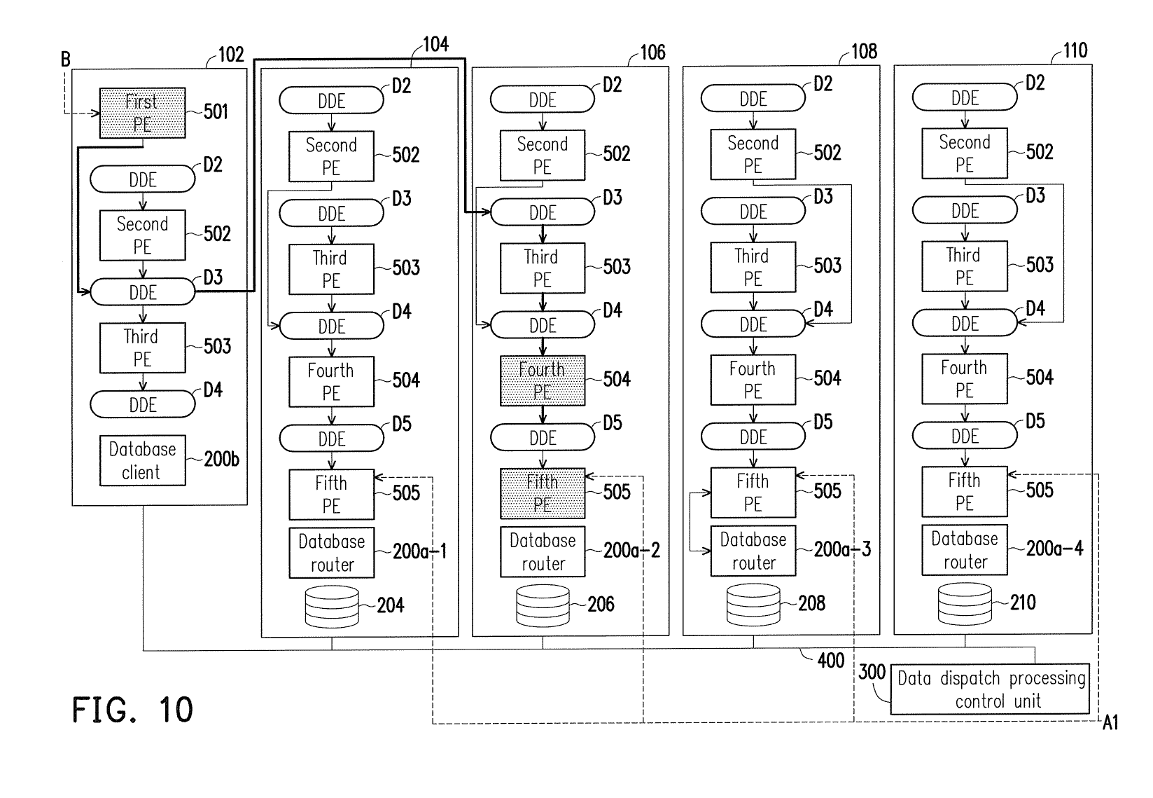

FIG. 10 is a schematic diagram illustrating another configuration of the processing elements (PE) and the data dispatch elements (DDE) according to the first exemplary embodiment of the disclosure.

Referring to FIG. 10, in detail, the more computing machines on which the processing elements and data dispatch elements are configured, the more flexible the data dispatch processing it is, since the multiple computing machines can provide more data dispatch processing paths, and the preferred execution path can be determined according to a data storage position, the data processing overhead or physical load of the computing machine itself and the data transmission cost between the computing machines. For example, when the database index is queried through the database client 200b, it is learned that the data tuple is required to be written in the fifth processing element 505 where the database accessing point A1 is located, and the number of the corresponding data nodes of the database accessing points of different data tuples for this example is four (204, 206, 208 and 210), and the data nodes are respectively located on the second computing machine 104, the third computing machine 106, the fourth computing machine 108 and the fifth computing machine 110. The processing element configuration module 304 of the present exemplary embodiment configures the first processing element 501, the second processing element 502 and the third processing element 503 on the first computing machine 102, and configures the second processing element 502, the third processing element 503, the fourth processing element 504 and the fifth processing element 505 on the second computing machine 104, the third computing machine 106, the fourth computing machine 108 and the fifth computing machine 110, and meanwhile the data dispatch element configuration module 306 configures the corresponding data dispatch elements on the computing machines. In this way, the data transmission module 310 determines a computing execution path according to the routing table established by the routing table establishment module 308 and according to the weight values of the directed edges calculated according to the data processing overhead or physical load of the computing machine itself and the data transmission overhead between the computing machines. In the present embodiment, for example, the data tuple is required to be written into the data node 206 on the third computing machine 106 in the fifth processing element 505 where the database accessing point A1 is located, and meanwhile, the computing execution path determined by the data transmission module 310 is as follows: After the first processing element and the second processing element on the first computing machine 102 processes the data tuple, the data dispatch element D3 dispatches the data tuple to the data dispatch element D3 on the third computing machine 106. Then, after the third processing element 503 on the third computing machine 106 processes the data tuple, the data tuple is transmitted to the data dispatch element D4 on the same computing machine, and after the fourth processing element 504 and the fifth processing element 505 on the third computing machine 106 process the data tuple, and finally, the processed data tuple is written into the data node 206 through the database router 200a-2 on the third computing machine 106. The path that the processing element 502 of the first computing machine 102 processes the data tuple and the data dispatch element D3 on the first computing machine 102 dispatches the data tuple to the data dispatch element D3 on the third computing machine 106 and the third processing element 503 of the third computing machine 106 processes the data tuple cannot be provided by the processing elements and the data dispatch elements of FIG. 9. It should be noticed that the disclosure is not limited thereto, and in another exemplary embodiment, dispatch of the data tuple can be implemented through any data dispatch element.

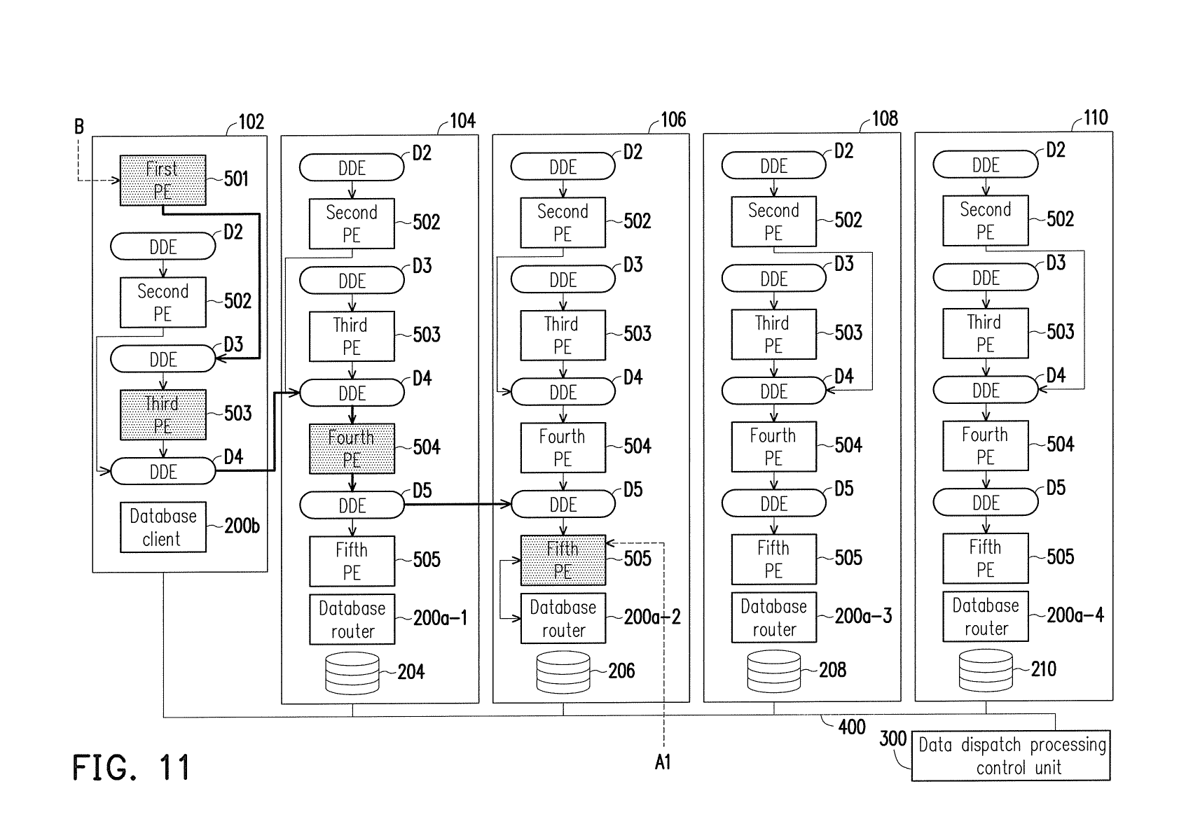

FIG. 11 is a schematic diagram of another data tuple dispatch processing path according to the first exemplary embodiment of the disclosure.

Referring to FIG. 11, the database accessing point A1 in the computing procedure is included in the fifth processing element 505 on the third computing machine 106, and the identified database index identification point B is included in the first processing element 501 on the first computing machine 102. In spite of the fact that it is learned at the first computing machine 102 that the data tuple is required to be written into the data node 206 on the third computing machine 106 in the fifth processing element 505 where the database accessing point A1 is located, in the present exemplary embodiment, the computing execution path determined by the data transmission module 310 is that until the data tuple is processed via the fourth processing element 504 on the second computing machine 104, the data tuple is dispatched to the data dispatch element D5 on the third computing machine 106 through the data dispatch element D5 on the second computing machine 104. Namely, dispatch of the data tuple is not limited to a specific data dispatch element and can be occurred on any data dispatch element.

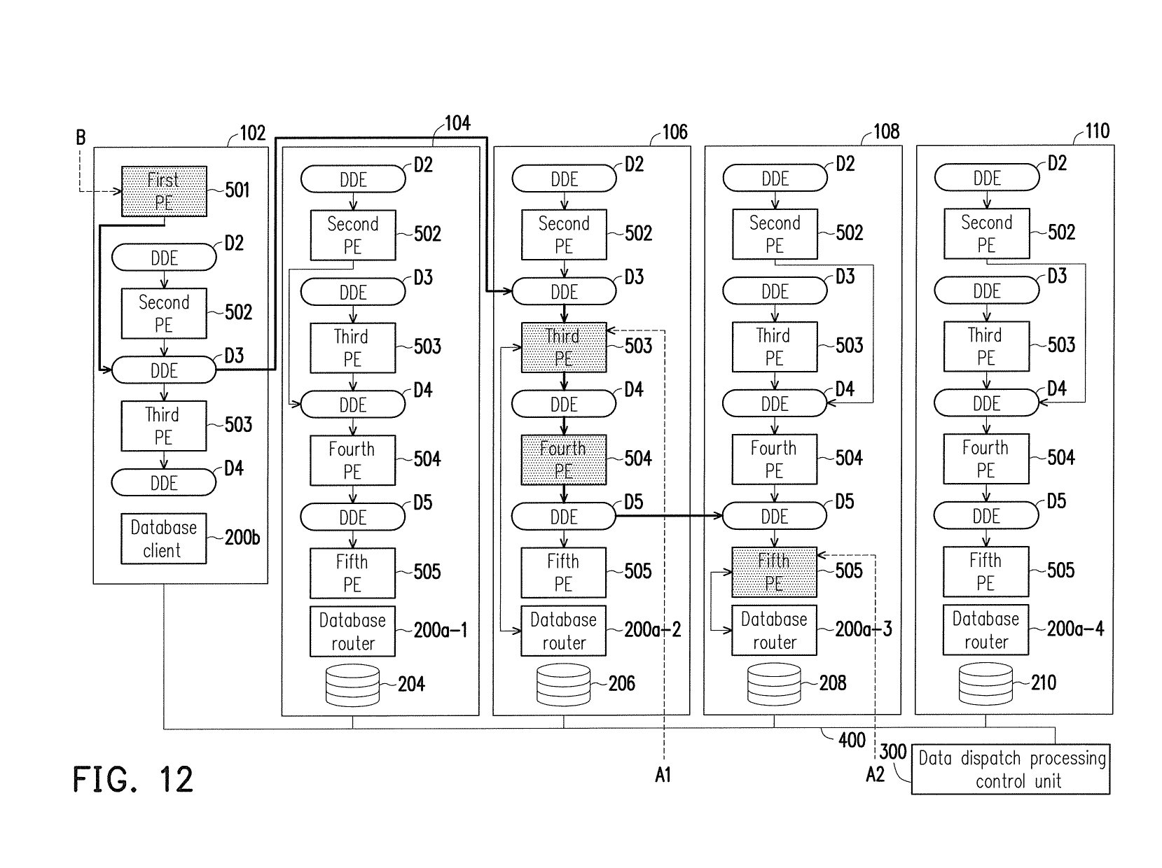

FIG. 12 is a schematic diagram of a data tuple dispatch processing path where two different data nodes are to be accessed in the computing procedure according to the first exemplary embodiment of the disclosure.

Referring to FIG. 12, the database index identification point B is also included in the first processing element 501 on the first computing machine 102, and what is different is that the computing procedure analysis module 302 identifies that the database accessing point A1 and the database accessing point A2 in the computing procedure are included in the third processing element 503 and the fifth processing element 505 respectively. Since in the computing procedure, the data tuple is required to access the data node 206 at the third processing element 503 in the third computing machine 106, and to access the data node 208 at the fifth processing element 505 in the fourth computing machine 108, in the computing execution path determined by the data transmission module 310, the data transmission module 310 will perform the data tuple dispatch according to the database index at the data dispatch element (DDE) D3 of the first computing machine 102 and the data dispatch element D5 of the third computing machine 106 respectively.

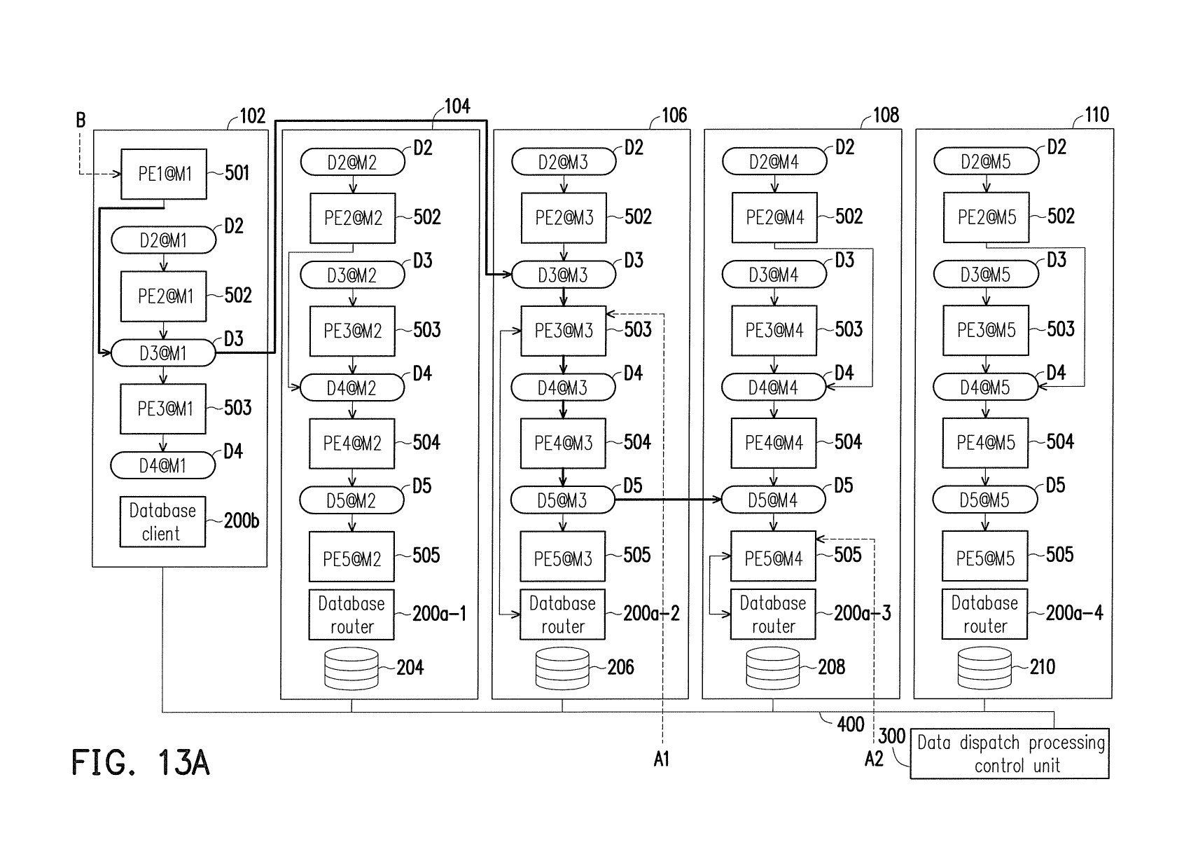

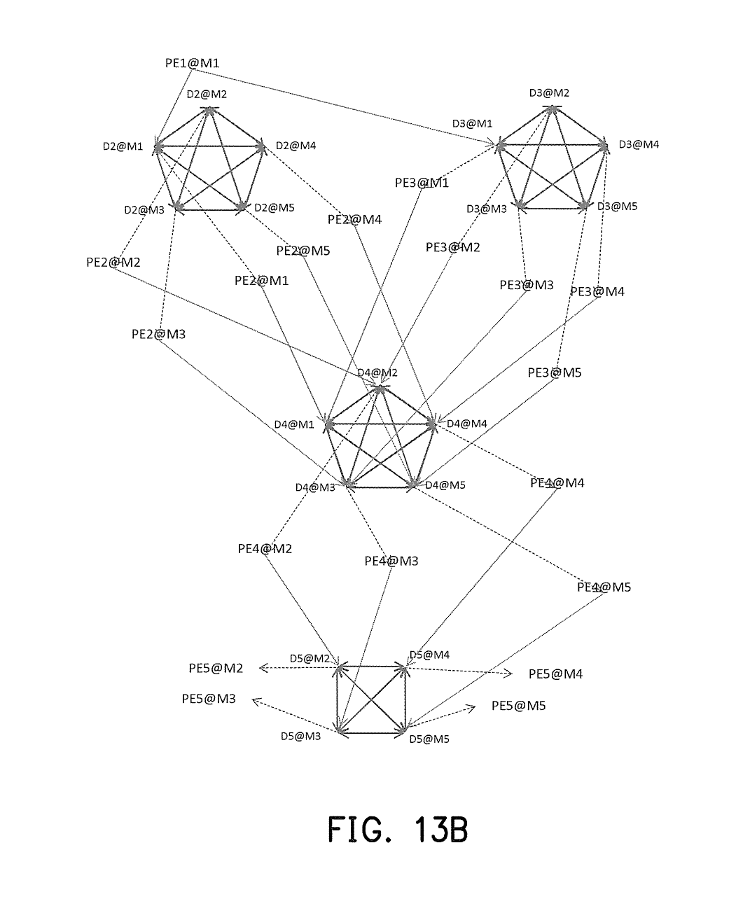

FIG. 13A and FIG. 13B illustrate a directed graph with a plurality of vertices formed by the processing elements and the data dispatch elements according to the first exemplary embodiment of the disclosure.

Referring to FIG. 13A, FIG. 13A is the diagram of FIG. 12 in which the elements are denoted by English abbreviations to facilitate distinguishing the processing elements and the data dispatch elements on the computing machines. PE1@M1 represents the first processing element on the first computing machine, and D2@M1 represents the data dispatch element D2 on the first computing machine, etc.

Referring to FIG. 13B, the routing table establishment module 308 establishes the directed graph with vertices formed by the processing elements and the data dispatch elements. For example, D2@M1, D2@M2, D2@M3, D2@M4 and D2@M5 are the data dispatch element D2 located on the first computing machine 102, the second computing machine 104, the third computing machine 106, the fourth computing machine 108 and the fifth computing machine 110, where each of the data dispatch elements D2 serves as a vertex. PE2@M1, PE2@M2, PE2@M3, PE2@M4 and PE2@M5 are the second processing element 502 located on the first computing machine 102, the second computing machine 104, the third computing machine 106, the fourth computing machine 108 and the fifth computing machine 110, where each of the second processing elements 502 also serves as a vertex. The routing table establishment module 308 links the vertices of the data dispatch elements to the vertices of the corresponding processing elements to construct directed edges of data transmission. The direction of the directed edge represents a data transmission direction. For example, the vertex PE2@M2 has two directed edges, where one directed edge points to PE2@M2 from D2@M2, and another directed edge points to D4@M2 from PE2@M2. The data dispatch elements with the same name on different computing machines can transmit the data tuple there between, for example, the data dispatch element D2 on the first computing machine 102 (indicated as D2@M1 in the directed graph), the data dispatch element D2 on the second computing machine 104 (indicated as D2@M2 in the directed graph), the data dispatch element D2 on the third computing machine 106 (indicated as D2@M3 in the directed graph), the data dispatch element D2 on the fourth computing machine 108 (indicated as D2@M4 in the directed graph) and the data dispatch element D2 on the fifth computing machine 110 (indicated as D2@M5 in the directed graph) may transmit the data tuple there between, so that there are 20 directed edges are linked to each other between the 5 vertices, and the 20 directed edges are 10 pairs of the directed edges with opposite directions. The routing table establishment module 308 calculates a weight value corresponding to each of the directed edges according to the group consisted of the data transmission overhead, the data processing overhead and the physical load of the corresponding each of the directed edges. The routing table establishment module 308 further calculates the shortest path between at least one vertex corresponding to at least one processing element containing at least one database accessing point and the vertex of the corresponding at least one data dispatch element, and establishes the routing table for each of the data dispatch elements according to the calculated shortest path.

### Second Exemplary Embodiment

A method and a system for data dispatch processing of the second exemplary embodiment are substantially the same to the method and the system for data dispatch processing of the first exemplary embodiment, and a difference there between is that in the second exemplary embodiment, a plurality of different data tuples are dynamically dispatched. Since one database accessing point generally corresponds to a plurality of different data nodes, the data nodes are found according to the database index to dynamically configure the data dispatch elements to the corresponding computing machines. The system and the component referential numbers of the first exemplary embodiment are used to describe the difference between the second exemplary embodiment and the first exemplary embodiment.

In the present exemplary embodiment, when the first computing machine 102 executes the processing elements, the data transmission module 310 determines whether the computing procedure analysis module 302 has identified the database index required by the data tuple.

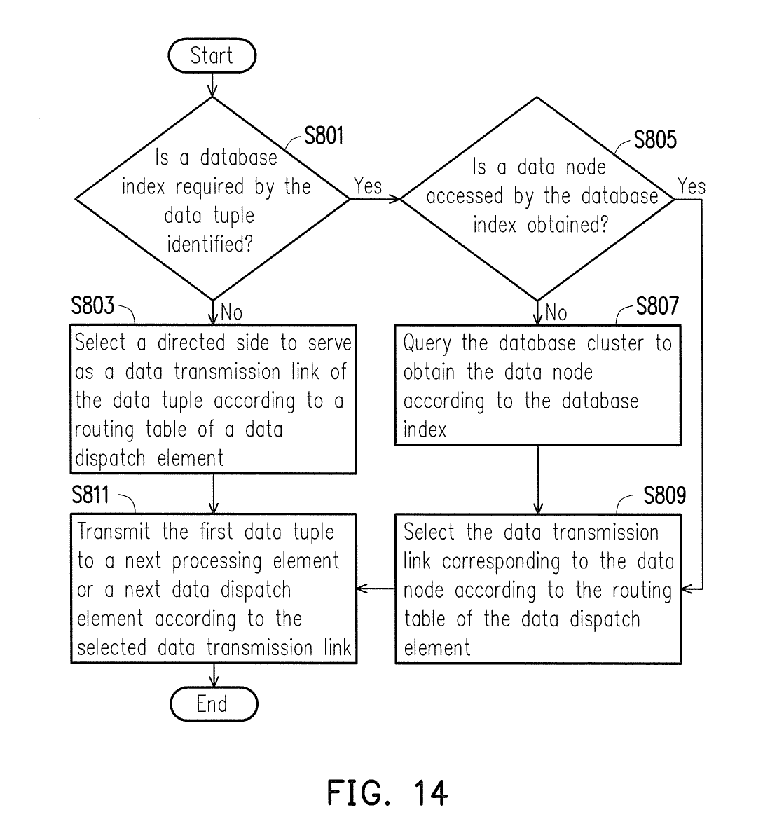

FIG. 14 is a flowchart illustrating dispatching the data tuple according to the second exemplary embodiment of the disclosure.

Referring to FIG. 14, first of all, in step S801, the data transmission module 310 determines whether a first database index required by a first data tuple in at least one data tuple is identified.

In the step S801, if the first database index required by the first data tuple is not identified before the data dispatch processing, in step S803, the data transmission module 310 randomly selects a directed edge to serve as a data transmission link corresponding to the first data tuple according to a routing table of a data dispatch element corresponding to a first target processing element.

In the step S801, if the first database index required by the first data tuple is already identified, and in step S805, a first data node accessed by the first database index is not obtained, in step S807, the data transmission module 310 further queries the database cluster to obtain the first data node according to the first database index. Then, in step S809, the data transmission module 310 selects the shortest path corresponding to a first target data node accessed by the first database index in the at least one target data node to serve as the data transmission link corresponding to the first data tuple according to the routing table corresponding to the data dispatch element of a first target processing element and according to the weight values calculated according to the data processing overhead, the physical load required by the computing machine itself and the data transmission overhead between the computing machines.

Conversely, if it is determined that the first data node accessed by the first database index is already obtained in the step S805, the data transmission module 310 directly execute the aforementioned optimisation step S809 to improve the system performance.

Then, after the data transmission module 310 completes the step of selecting the data transmission link in the step S803 or the step S809, in step S811, the first data tuple is transmitted to a next target processing element or a next data dispatch element according to the data transmission link corresponding to the first data tuple.

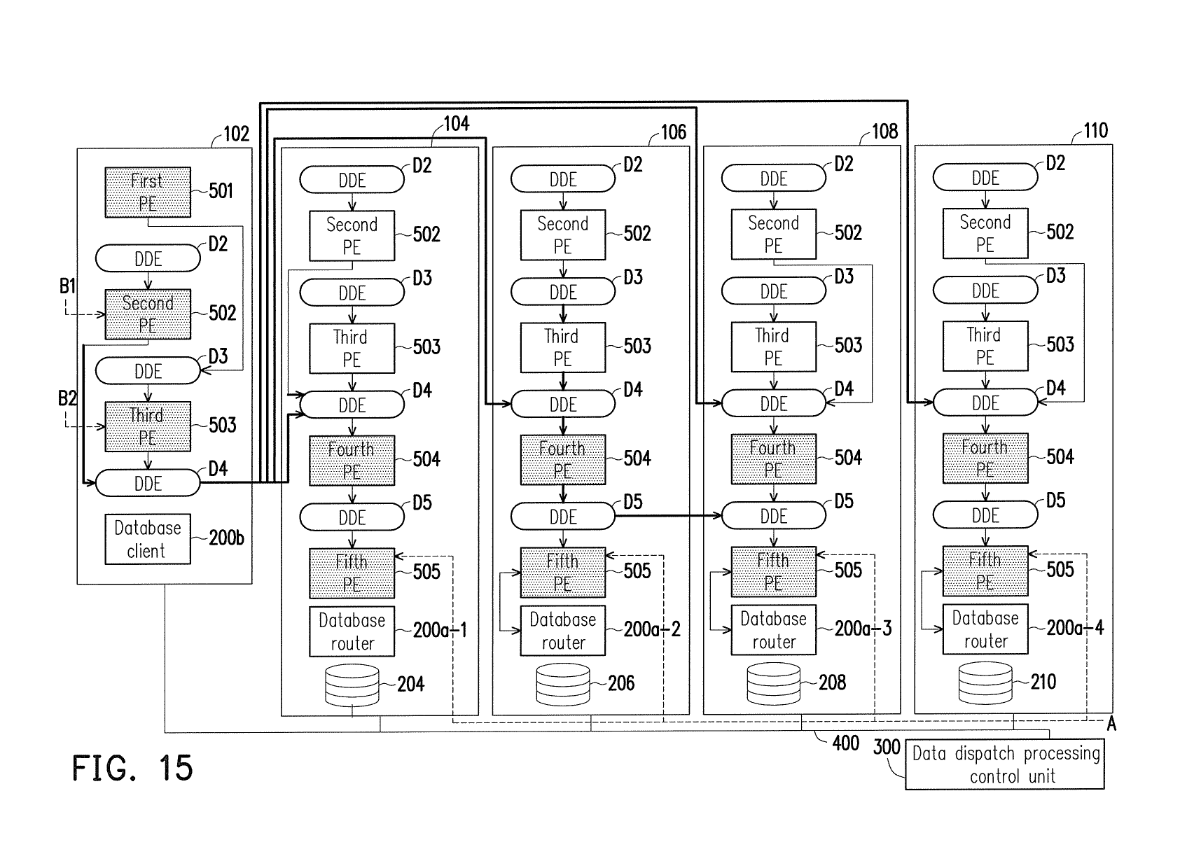

FIG. 15 is a schematic diagram of a processing path for immediately dispatching a data tuple in light of the database index according to the second exemplary embodiment of the disclosure.

Referring to FIG. 15, first of all, the computing procedure analysis module 302 identifies the database accessing point A used for accessing a target data node in the data nodes in the computing procedure. Then, the computing procedure analysis module 302 identifies database index identification points B1 and B2 corresponding to the database accessing point A, i.e. identifies that the database accessing point A in the computing procedure is included in each of the fifth processing elements 505 in the second computing machine 104 to the fifth computing machine 110, and the database index identification points B1 and B2 are included in the second processing element 502 and the third processing element 503 in the first computing machine 102. In order to immediately query the corresponding data node after the second processing element 502 and the third processing element 503 in the first computing machine 102 obtain the database index, the processing element configuration module 304 configures the second processing element including the database index identification point B1 and the third processing element including the database index identification point B2 to the computing machine having a database router or a database client, for example, in the present embodiment, the first computing machine 102 is selected, and the processing elements 502-505 are respectively configured to the second computing machine 104 to the fifth computing machine 110 having the data nodes 204, 206, 208 and 210 and the database routers 200a-1˜200a-4. It should be noticed that in the second exemplary embodiment of the disclosure, a configuration that the fourth processing element 504 and the fifth processing element 505 are respectively configured to the second computing machine 104 to the fifth computing machine 110 can be implemented. In such configuration, since the second and the third processing elements are configured to the first computing machine 102 to process the data tuple, the computing machines of the post computing procedure are considered to be configured with the fourth processing element 504 and the fifth processing element 505, and the difference between the present configuration and the former configuration is that the former configuration has better transmission flexibility, and the present configuration has less occupied resource. Then, the data dispatch element configuration module 306 configures the data dispatch elements corresponding to the processing elements.

Referring further to FIG. 15, when the data tuple is processed in the first computing machine 102, and if the first database index required by the first data tuple still cannot be identified, the data transmission module 310 selects a directed edge to serve as a data transmission link corresponding to the first data tuple according to a routing table of a data dispatch element corresponding to a first target processing element, and in the present embodiment, the data dispatch element D4 of the first computing machine 102 selects to transmit data to the data dispatch element D4 of one of the second computing machine 104, the third computing machine 106, the fourth computing machine 108 and the fifth computing machine 110 or transmit data according to transmission of historical data. However, before the data dispatch element D4 of the first computing machine 102 dispatches, if the database index is already identified, the data transmission module 310 learns a preferred path according to real-time situation, and transmits the data tuple to a next target processing element or a next data dispatch element according to the preferred path.

In summary, in the method for data dispatch processing of the disclosure, by identifying the physical machine where each batch of data in the computing procedure is stored, data transmission generated for accessing database is reduced in the system with big data computation and data storage. Moreover, in the method for data dispatch processing of the disclosure, the processing elements and the data dispatch elements on each of the physical machines are dynamically configured according to the individual database index of each data tuple and the system status, and the data tuple is dynamically transmitted to the proper physical machine. In this way, on one hand, the hardware resources of different physical machines can be used to execute the processing elements, i.e. data computation and storage are dispersed to various physical machines in the system to improve the system performance, capacity and extensibility, on the other hand, the proper data processing path can be dynamically selected to reduce a burden of data transmission.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for data dispatch processing in a big data system, adapted to execute a computing procedure through a plurality of computing machines and a database cluster, wherein the database cluster has a plurality of data nodes, and each of the data nodes is configured in one of the computing machines, the method for data dispatch processing comprising:
analysing the computing procedure to disassemble the computing procedure into a plurality of processing elements;
identifying at least one database accessing point for accessing at least one target data node in the data nodes in the computing procedure, wherein the at least one database accessing point is located in at least one processing element in the processing elements;
configuring the processing elements corresponding to the database accessing points to the computing machines according to the at least one database accessing point; and
transmitting at least one data tuple corresponding to the computing procedure according to the processing elements configured to the computing machines and a data transmission cost between the computing machines.

2. The method for data dispatch processing as claimed in claim 1, further comprising:
identifying at least one database index identification point corresponding to the at least one database accessing point in the computing procedure, wherein the at least one database index identification point is located in at least one processing element in the processing elements;
identifying at least one database index at the at least one database index identification point; and
querying the database cluster to obtain the at least one target data node according to the at least one database index.

3. The method for data dispatch processing as claimed in claim 2, wherein the step of configuring the processing elements corresponding to the database accessing points to the computing machines according to the at least one database accessing point comprises:
configuring the at least one processing element corresponding to comprising the at least one database accessing point in the processing elements to at least one computing machine in the computing machines, wherein the at least one computing machine is configured with the at least one target data node corresponding to the at least one database accessing point.

4. The method for data dispatch processing as claimed in claim 3, wherein the step of configuring the processing elements corresponding to the database accessing points to the computing machines according to the at least one database accessing point comprises:
configuring the at least one processing element corresponding to comprising the at least one database accessing point in the processing elements to at least one computing machine in the computing machines, wherein the at least one computing machine is configured with a database router or a database client corresponding to the database cluster.

5. The method for data dispatch processing as claimed in claim 4, further comprising:
configuring the at least one processing element corresponding to comprising the at least one database index identification point in the processing elements to the at least one computing machine in the computing machines, wherein the at least one computing machine is configured with the database client or the database router corresponding to the database cluster.

6. The method for data dispatch processing as claimed in claim 5, wherein the step of after configuring the at least one processing element comprising the at least one database accessing point in the processing elements to at least one computing machine in the computing machines comprises:
respectively configuring each of the processing elements other than the at least one processing element comprising the at least one database accessing point in the processing elements and the at least one processing element comprising the at least one database index identification point in the processing elements to different computing machines in the computing machines.

7. The method for data dispatch processing as claimed in claim 5, wherein the step of after configuring the at least one processing element comprising the at least one database accessing point in the processing elements to at least one computing machine in the computing machines comprises:
configuring each of the processing elements other than the at least one processing element comprising the at least one database accessing point in the processing elements and the at least one processing element comprising the at least one database index identification point in the processing elements to at least one computing machine in the computing machines.

8. The method for data dispatch processing as claimed in claim 1, further comprising:
finding a data transmission link corresponding to each of the processing elements according to the disassembling, and configuring a data dispatch element for each of the processing element according to the data transmission links.

9. The method for data dispatch processing as claimed in claim 1, wherein the step of transmitting the at least one data tuple corresponding to the computing procedure according to the processing elements configured to the computing machines and the data transmission cost between the computing machines comprises:
establishing a routing table for each of a data dispatch elements according to the processing elements configured to the computing machines and the data transmission cost between the computing machines.

10. The method for data dispatch processing as claimed in claim 9, wherein the step of establishing the routing table for each of the data dispatch elements according to the processing elements configured to the computing machines and the data transmission cost between the computing machines comprises:
establishing a directed graph with a plurality of vertices formed by the processing elements and the data dispatch elements;
establishing a plurality of directed edges between the vertices of the directed graph according to the computing procedure;
calculating a weight value corresponding to each of the directed edges according to a data transmission overhead, a data processing overhead and a physical load corresponding to each of the directed edges;
calculating a shortest path between at least one vertex corresponding to the at least one processing element comprising the at least one database accessing point and a vertex corresponding to each of the data dispatch elements; and
establishing the routing tables of the data dispatch elements according to the shortest paths.

11. The method for data dispatch processing as claimed in claim 9, wherein the step of transmitting the at least one data tuple corresponding to the computing procedure according to the processing elements configured to the computing machines and the data transmission cost between the computing machines further comprises:
selecting a target processing element corresponding to each of the processing element from the processing elements of the computing machines to form a computing execution path corresponding to the computing procedure; and
transmitting the at least one data tuple corresponding to the computing procedure according to the computing execution path and the routing tables of the data dispatch elements.

12. The method for data dispatch processing as claimed in claim 9, wherein the step of transmitting the at least one data tuple corresponding to the computing procedure according to the processing elements configured to the computing machines and the data transmission cost between the computing machines further comprises:
determining whether a first database index required by a first data tuple in the at least one data tuple is identified when a first computing machine in the computing machines operates a first target processing element in the processing elements;
if the first database index required by the first data tuple is not identified, selecting a directed edge to serve as a data transmission link corresponding to the first data tuple according to a routing table of a data dispatch element corresponding to the first target processing element;
if the first database index required by the first data tuple is identified, selecting a corresponding data transmission link corresponding to a first target data node accessed by the first database index in the at least one target data node to serve as a data transmission link corresponding to the first data tuple according to the routing table of the data dispatch element corresponding to the first target processing element; and
transmitting the first data tuple to a next target processing element or a next data dispatch element according to the data transmission link corresponding to the first data tuple.

13. The method for data dispatch processing as claimed in claim 12, further comprising:
determining whether the first data node accessed by the first database index in the at least one target data node is obtained; and
if the first data node accessed by the first database index is not obtained, querying the database cluster to obtain the first data node according to the first database index.

14. A system for data dispatch processing in a big data system, adapted to execute a computing procedure, the system for data dispatch processing comprising:
a plurality of computing machines, connected to each other through a network;
a database cluster, having a plurality of data nodes, wherein each of the data nodes is disposed in one of a plurality of computing machines; and
a data dispatch processing control unit, configured to analysis the computing procedure to disassemble the computing procedure into a plurality of processing elements,
wherein the dispatch processing control unit is further configured to identify at least one database accessing point for accessing at least one target data node of the data nodes in the computing procedure, wherein the at least one database accessing point is located in at least one processing element in the processing elements,
wherein the data dispatch processing control unit is further configured to configure the processing elements corresponding to the database accessing points to the computing machines according to the at least one database accessing point,
wherein the data dispatch processing control unit is further configured to transmit at least one data tuple corresponding to the computing procedure according to the processing elements configured to the computing machines and a data transmission cost between the computing machines.

15. The system for data dispatch processing as claimed in claim 14, wherein the data dispatch processing control unit further comprises a computing procedure analysis module,
wherein the computing procedure analysis module is configured to identify at least one database index identification point corresponding to the at least one database accessing point in the computing procedure, wherein the at least one database index identification point is located in at least one processing element in the processing elements,
wherein the computing procedure analysis module is further configured to identify at least one database index at the at least one database index identification point,
wherein the computing procedure analysis module is further configured to query a database cluster to obtain the at least one target data node according to the at least one database index.

16. The system for data dispatch processing as claimed in claim 15, wherein the data dispatch processing control unit comprises a processing element configuration module,
wherein the processing element configuration module is configured to have the at least a processing element of the corresponding one that comprises the at least one database accessing point in the processing elements configure to the at least one computing machine in the computing machines, wherein the at least one computing machine is configured with the at least one target data node corresponding to the at least one database accessing point.

17. The system for data dispatch processing as claimed in claim 16, wherein the data dispatch processing control unit comprises a processing element configuration module,
wherein the processing element configuration module is configured to configure the at least one processing element corresponding to comprising the at least one database accessing point in the processing elements to at least one computing machine in the computing machines, wherein the at least one computing machine is configured with a database router or a database client corresponding to the database cluster.

18. The system for data dispatch processing as claimed in claim 17, wherein the processing element configuration module is further configured to configure the at least one processing element corresponding to comprising the at least one database index identification point in the processing elements to the at least one computing machine in the computing machines, wherein the at least one computing machine is configured with the database client or the database router corresponding to the database cluster.

19. The system for data dispatch processing as claimed in claim 18, wherein the processing element configuration module is configured to respectively configure each of a processing elements other than the at least one processing element comprising the at least one database accessing point in the processing elements and the at least one processing element comprising the at least one database index identification point in the processing elements to different computing machines in the computing machines.

20. The system for data dispatch processing as claimed in claim 18, wherein the processing element configuration module is configured to configure each of the processing elements other than the at least one processing element corresponding to comprising the at least one database accessing point in the processing elements and the at least one processing element corresponding to comprising the at least one database index identification point in the processing elements to at least one computing machine in the computing machines.

21. The system for data dispatch processing as claimed in claim 14, wherein the data dispatch processing control unit comprises a data dispatch element configuration module,
wherein the data dispatch element configuration module is configured to find a data transmission link corresponding to each of the processing elements according to the disassembling, and configure a data dispatch element for each of the processing element according to the data transmission links.

22. The system for data dispatch processing as claimed in claim 14, wherein the data dispatch processing control unit comprises a routing table establishment module configured to establish a routing table for each of the data dispatch elements according to the processing elements configured to the computing machines and the data transmission cost between the computing machines.

23. The system for data dispatch processing as claimed in claim 22,
wherein the routing table establishment module is further configured to establish a directed graph with a plurality of vertices formed by the processing elements and the data dispatch elements,
wherein the routing table establishment module is further configured to establish a plurality of directed edges between the vertices of the directed graph according to the computing procedure,
wherein the routing table establishment module is further configured to calculate a weight value corresponding to each of the directed edges according to a data transmission overhead a data processing overhead and a physical load corresponding to each of the directed edges;
wherein the routing table establishment module is further configured to calculate a shortest path between at least one vertex corresponding to the at least one processing element comprising the at least one database accessing point and a vertex corresponding to each of the data dispatch elements,
wherein the routing table establishment module is further configured to establish the routing tables of the data dispatch elements according to the shortest paths.

24. The system for data dispatch processing as claimed in claim 22, wherein the data dispatch processing control unit further comprises a data transmission module configured to select a target processing element corresponding to each of the processing element from the processing elements of the computing machines to form a computing execution path corresponding to the computing procedure,
wherein the processing elements executes the computing procedure according to the computing execution path, and the data dispatch elements transmit the at least one data tuple corresponding to the computing procedure according to the routing tables.

25. The system for data dispatch processing as claimed in claim 22, wherein the data dispatch processing control unit further comprises a data transmission module,
wherein when a first computing machine in the computing machines operates a first target processing element in the processing elements, the data transmission module is configured to determine whether a first database index required by a first data tuple in the at least one data tuple is identified,
wherein if the first database index required by the first data tuple is not identified, the data transmission module is configured to select a directed edge to serve as a data transmission link corresponding to the first data tuple according to a routing table of a data dispatch element corresponding to the first target processing element,
wherein if the first database index required by the first data tuple is identified, the data transmission module is configured to select a corresponding data transmission link corresponding to a first target data node accessed by the first database index in the at least one target data node to serve as a data transmission link corresponding to the first data tuple according to the routing table of the data dispatch element corresponding to the first target processing element,
wherein the data transmission module is configured to transmit the first data tuple to a next target processing element or a next data dispatch element according to the data transmission link corresponding to the first data tuple.

26. The system for data dispatch processing as claimed in claim 25, wherein the data transmission module is further configured to determine whether the first data node accessed by the first database index in the at least one target data node is obtained,
wherein if the first data node accessed by the first database index is not obtained, the data transmission module queries the database cluster to obtain the first data node according to the first database index.
